(19) United States
(12) Patent Application Publication
(10) Pub. No.: US 2022/0044288 A1
(43) Pub. Date: Feb. 10, 2022

(54) DIGITAL LIVE BOOK PRODUCTION SYSTEM

(71) Applicant: WAYNEHILLS VENTURES LLC, Seongnam-si, Gyeonggi-do (KR)

(72) Inventor: Su Min YI, Gimpo-si, Gyeonggi-do (KR)

(21) Appl. No.: 17/413,180

(22) PCT Filed: Dec. 11, 2019
(86) PCT No.: PCT/KR2019/017518

§ 371 Date: Jun. 11, 2021

(30) Foreign Application Priority Data
Dec. 11, 2018 (KR) 10-2018-0158954

(51) Int. Cl. G06Q 30/02; G06F 16/438; G06T 11/60; H04L 12/58

(52) U.S. Cl. CPC G06Q 30/0282; H04L 51/02; G06T 11/60; G06F 16/4393

(57) ABSTRACT

This application relates to a digital live book production system for converting the contents of a book into multimedia contents, thus enabling a user to learn the contents of the book quickly and in an interesting way. In one aspect, the digital live book production system includes a book input unit to which sentences of a book are input and an image generation unit configured to generate images corresponding to contents of the sentences input to the book input unit. The system may also include an image alignment unit configured to arrange the images in one screen frame according to the contents of the sentences. The system may further include a screen frame arrangement unit configured to select some screen frames and connect the selected screen frames according to a story of a book, to generate a digital live book.

### TECHNICAL FIELD

The disclosure relates to a digital live book production system, and more particularly, to a digital live book production system which converts the contents of a book into multimedia contents, thus enabling a user to learn the contents of the book quickly and in an interesting way.

### BACKGROUND ART

As the spread of smartphones increases and information-providing apps using smartphones develop, the amount of reading done by people today is rapidly decreasing. In addition, reading a large number of books from the beginning to the end is a burden for people today who lack time for reading, and determining which book to choose from among numerous books is also very difficult.

Accordingly, many studies have been conducted to allow readers to access books more easily by providing readers with summaries of the contents of books.

### DESCRIPTION OF EMBODIMENTS

### Technical Problem

Provided is a digital live book production system which converts the contents of a book into multimedia contents, thus enabling a user to learn the contents of the book quickly and in an interesting way.

Provided is a digital live book production system that enables a chatbot to continuously assign behavioral tasks to a user who has viewed multimedia contents to prompt a behavioral change of the user.

Provided is a digital live book production system that provides visual video contents to allow people to be interested in books in a more fun and interesting way through an artificial intelligence technology and a digital contents service, and makes people be more curious about the contents of books to prompt people to purchase and read the books.

The technical problem to be achieved by the digital live book production system according to the present disclosure is not limited to the above-mentioned problems, and another problems that are not mentioned will be clearly understood by those skilled in the art from the following description.

### Solution to Problem

One and more embodiments include a digital live book production system, including: a book input unit to which sentences of a book are input; an image generation unit configured to generate images corresponding to contents of the sentences input to the book input unit; an image alignment unit configured to arrange the images in one screen frame according to the contents of the sentences; and a screen frame arrangement unit configured to select some screen frames and connect the selected screen frames according to a story of a book, to generate a digital live book.

The digital live book production system may further include a chatbot unit configured to transmit a mission related to a digital live book to a user who has finished reading a digital live book and transmit a message that prompts the user to perform the mission.

The image generation unit may receive images corresponding to sentences and match the collected images for each sentence.

The image generation unit may transmit a sentence and images matching the sentence to terminals of members, transmit a question message to select an image that best expresses the sentence, and determine an image that has received the most selections from members as an image that matches the sentence.

The image alignment unit may arrange images matching a sentence in one screen frame.

The image alignment unit may arrange images matching two or more sentences together in one screen frame.

The image alignment unit may transmit images arranged in the screen frame to terminals of members, enable the members to drag the images on the terminals and rearrange the images in the screen frame, receive, from the terminals of the members, screen frames in a final rearranged state, and determine the most similar arrangement to that created by the most members as an image arrangement in the screen frame.

When images matching a same word among images determined for each screen frame are different, the screen frame arrangement unit may change the different images matching the same word to a same image.

The digital live book production system may further include an e-book feedback unit configured to receive a reading pattern of an e-book subscribed to by members from e-book terminals of the members, wherein the screen frame arrangement unit may select a screen frame including sentences corresponding to a page that the members repeatedly viewed in the e-book, as a screen frame to be selected according to a book story.

The digital live book production system may further include an audio generation unit configured to collect sounds corresponding to contents of the sentences input to the book input unit, match the collected sounds for each sentence, and output a sound when a screen frame including a sentence is displayed.

### Advantageous Effects of Disclosure

A digital live book production system according to embodiments of the present disclosure has the following effects.

(1) Contents of a book are converted into multimedia contents, thus enabling a user to learn the contents of the book quickly and in an interesting way.

(2) A chatbot continuously assigns behavioral tasks to a user who has viewed the multimedia contents, thus prompting a change in the user's behavior.

(3) People may be enabled to be interested in books in a more fun and interesting way by providing them with visual video contents through an artificial intelligence technology and digital content services.

(4) Making people be more curious about the contents of books to prompt people to purchase and read the books.

However, effects that may be achieved by the digital live book production system according to embodiments of the present disclosure are not limited to those mentioned above, and other effects not mentioned may be clearly understood by those skilled in the art from the following description.

### BRIEF DESCRIPTION OF DRAWINGS

A brief description of each drawing is provided for more fully understanding the drawings cited in the present disclosure.

FIG. 1 is a schematic diagram of a digital live book production system according to an embodiment of the present disclosure.

FIG. 2 is a flowchart illustrating an implementation of a digital live book production system according to an embodiment of the present disclosure.

FIG. 3 is a diagram illustrating generation of images matching a sentence of a book in a digital live book production system according to an embodiment of the present disclosure.

FIG. 4 is a diagram illustrating a case where a chatbot unit assigns a mission to a user terminal in a digital live book production system according to an embodiment of the present disclosure.

### BEST MODE

As the present disclosure allows for various changes and numerous embodiments, particular embodiments will be illustrated in the drawings and described in detail in the written description. However, this is not intended to limit the present disclosure to particular embodiments, and it is to be understood that all changes, equivalents, and substitutes that are included in the spirit and technical scope of the present disclosure are encompassed in the present disclosure.

In the description, certain detailed explanations of the related art are omitted when it is deemed that they may unnecessarily obscure the essence of the present disclosure. While such terms as “first,” “second,” etc., that are used to describe the present disclosure, are used only to distinguish one element from another.

In addition, in the present disclosure, in the case where a component is described as “being connected to” or “being accessed to” another component, although the component may be directly connected or directly accessed to another component, descriptions shall be understood that other components may be interposed therebetween to be connected and accessed unless otherwise described.

In addition, in the present disclosure, in cases where components are represented by ‘unit’, two or more components may be combined into one component, or one component may be divided into two or more for each more subdivided function. In addition, hereinafter, each of components to be described may also additionally perform some or all functions that other components are responsible for, in addition to a main function that is responsible for, and some of main functions that each component is responsible for may be dedicated and performed by other components.

Hereinafter, embodiments according to the present disclosure will be sequentially described in detail.

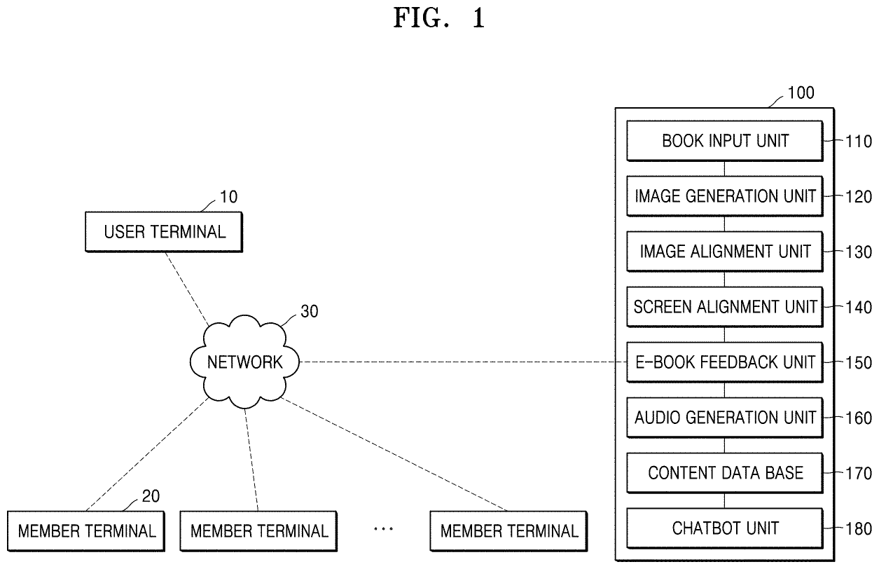

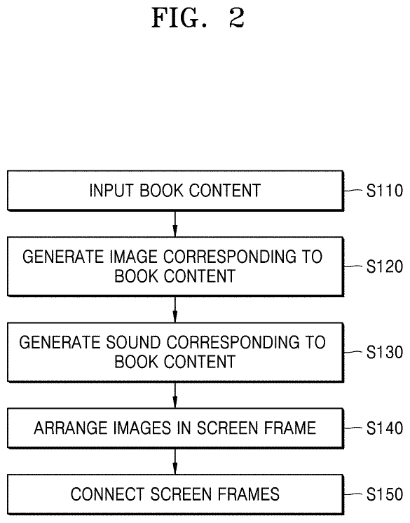

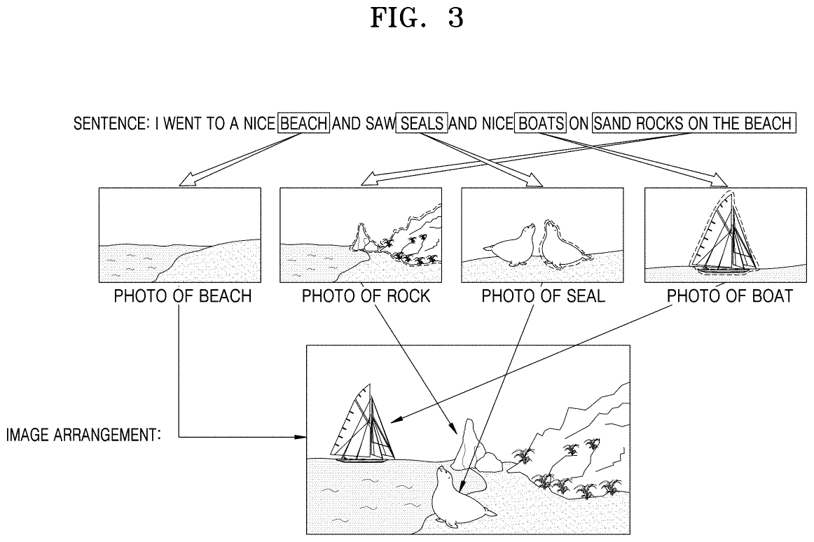

FIG. 1 is a schematic diagram of a digital live book production system according to an embodiment of the present disclosure. FIG. 2 is a flowchart illustrating an implementation of a digital live book production system according to an embodiment of the present disclosure. FIG. 3 is a diagram illustrating generation of images matching a sentence of a book in a digital live book production system according to an embodiment of the present disclosure.

A digital live book production system 100 according to an embodiment of the present disclosure may be connected to a user terminal 10 and a member terminal 20 through a network 30, and may include a book input unit 110, an image generation unit 120, an image alignment unit 130, a screen frame arrangement unit 140, an e-book feedback unit 150, an audio generation unit 160, a content database 170, and a chatbot unit 180.

A user and a member may transmit and receive signals to/from the digital live book production system 100 by accessing the digital live book production system 100 by using the user terminal 10 and the member terminal 20. An application accessible to the digital live book production system 100 is preferably installed and driven in the user terminal 10 and the member terminal 20.

The user terminal 10 and the member terminal 20 may be implemented as a computer that may access a remote server or a terminal through a network. Herein, the computer may include, for example, a notebook equipped with a web browser, a desktop, a laptop, or the like. In addition, a terminal may be implemented as a terminal device which may access a remote server or a terminal through a network. The terminal device may be, for example, a wireless communication device in which portability and mobility are guaranteed, and may include a Personal Communication System (PCS) terminal, a Global System for Mobile communications (GSM) terminal, a Personal Digital Cellular (PDC) terminal, a Personal Handy-phone System (PHS) terminal, a Personal Digital Assistant (PDA), an International Mobile Telecommunication (IMT)-2000 terminal, a Code Division Multiple Access (CDMA)-2000 terminal, a W-Code Division Multiple Access (W-CDMA) terminal, a Wireless Broadband Internet (Wibro) terminal, and all types of handheld-based communication devices such as a smartphone, a smartpad, and a tablet personal computer (PC), or the like.

Herein, the network 30 refers to a connection structure capable of exchanging information between each of nodes such as a plurality of terminals and servers, and examples thereof include a 3rd Generation Partnership Project (3GPP) network, a Long Term Evolution (LTE) network, a World Interoperability for Microwave Access (WIMAX) network, Internet, a Local Area Network (LAN), Wireless LAN, a Wide Area Network (WAN), a Personal Area Network (PAN), a Bluetooth network, a satellite broadcasting network, an analog broadcasting network, a Digital Multimedia Broadcasting (DMB) network, or the like, but are not limited thereto.

Contents of a book 11 may be input to the book input unit 110 (S110). The contents of the book 11 may be input in units of sentences, units of paragraphs, or the like. The book input unit 110 may scan and receive contents of a book through an Optical Character Recognition (OCR) device. The book input unit 110 may receive contents of a book through a document file of a manuscript of a newly-published book uploaded by a publisher through the network 30.

The image generation unit 120 may generate images corresponding to contents of sentences input to the book input unit 110 (S120). The image generation unit 120 may generate images corresponding to the sentences through a parsing algorithm. Here, the images may include both of static images and dynamic images.

The image generation unit 120 may collect images corresponding to sentences from a web or the content database 170, and match the collected images for each sentence. For example, for a sentence of “I went to a nice beach and saw seals on sand rocks on the beach and nice boats”, the image generation unit 120 may classify the sentence into “beach”, “beach sand rocks”, “seals”, and “boats”, and collect images matching thereto from a web or the content database 170. Two or more images may be collected for one word, and the image generation unit 120 may collect and select an appropriate image through a machine learning technology, a deep learning technology, or the like.

Alternatively, the image generation unit 120 may transmit a particular sentence and images matching the particular sentence to member terminals 20 of members, and transmit a question message asking the members to select an image that best expresses the particular sentence. The members may select and transmit an image that best expresses the particular sentence through the member terminals 20 to the image generation unit 120, and the image generation unit 120 may determine an image that has been selected by most the of members as an image matching the particular sentence. The image generation unit 120 may compensate some or all of the members who have transmitted the image which has been selected the most. The image generation unit 120 may transmit an electronic coupon that may be exchanged for money or goods to the member terminal 20.

The audio generation unit 160 may generate a sound corresponding to the content of a sentence input to the book input unit 110 (S130). The audio generation unit 160 may generate a sound corresponding to a sentence through the parsing algorithm. Herein, the sound may include all of music, voice, and sound effects.

The audio generation unit 160 may collect sounds corresponding to sentences from a web or the content database 170 and match the collected sounds for each sentence. For example, for the sentence of “I went to a nice beach and saw seals on sand rocks on the beach and nice boats”, the audio generation unit 160 may classify the sentence into “beach”, “beach sand rocks”, “seals”, and “ports”, and collect sounds matching thereto from a web or the content database 170. Two or more sounds may be collected for one word, and the audio generation unit 160 may collect and select an appropriate sound through a machine learning technology, a deep learning technology, or the like.

Alternatively, the audio generation unit 160 may transmit a particular sentence and sounds matching the particular sentence to the member terminal 20 of the members, and transmit a question message asking the members to select a sound that best expresses the particular sentence. The members may select and transmit a sound that best expresses the particular sentence through the member terminals 20 to the audio generation unit 160, and the audio generation unit 160 may determine a sound that has been selected by most of the members as a sound matching the particular sentence. The audio generation unit 160 may compensate some or all of the members who have transmitted the sound which has been selected the most. The audio generation unit 160 may transmit an electronic coupon that may be exchanged for money or goods to the member terminal 20.

The image alignment unit 130 may arrange trimmed images in one screen frame according to the content of the sentence (S140). The image alignment unit 130 may trim only necessary objects from the collected and selected images. For example, a seal image may be only trimmed from an image of a seal in a zoo.

Contents of several sentences may be included in one screen frame, and the image alignment unit 130 may arrange trimmed images matching two or more sentences together in one screen frame. The image alignment unit 130 may select an appropriate image arrangement through a machine learning technology, a deep learning technology, or the like.

Alternatively, the image alignment unit 130 may transmit trimmed images arranged in a screen frame to the member terminals 20 of the members, and enable that the members may drag, enlarge, and reduce the trimmed images on the member terminals 20 to rearrange the trimmed images in the screen frame. The members may create and capture an image arrangement that best expresses a particular sentence through the user terminals 20 and then transmit the same to the image alignment unit 130, and the image alignment unit 130 may determine the most similar arrangement to that has been created by most the of members as an image arrangement matching the particular sentence. The image alignment unit 130 may compensate some or all of the members who have transmitted the image arrangement which has been selected the most. The image alignment unit 130 may transmit an electronic coupon that may be exchanged for money or goods to the member terminal 20.

The image alignment unit 130 may determine the similarity of the arrangement for each trimmed image to select the most similar arrangement. For example, a position of a “rock” may be confirmed by selecting an area that is the most selected for positioning with a trimmed “rock” image, and then a position of a “seal” may be confirmed by selecting an area that is the most selected for positioning a trimmed “seal” image.

The audio generation unit 160 may output a predetermined sound together when a screen frame including a particular sentence is displayed.

The screen frame arrangement unit 140 may select some of completed screen frames and connect the selected screen frames according to the story of a book (S150). All screen frames may be also connected, but it is preferable to select some frames to summarize the book in a limited time.

When trimmed images matching the same word among the images determined for each screen frame are different, the screen frame arrangement unit 140 may unify and change the different trimmed images to any one of the same trimmed images. Through this, the screen frames of the entire story may have unity.

The e-book feedback unit 150 may receive a reading pattern of an e-book subscribed by the members from e-book terminals of the members. A reading pattern of the members for an e-book of a book to be produced as a digital live book may include a pattern of repetitive viewing of a particular page, a pattern of quickly passing through a particular page, a pattern of fluorescent-marking on sentences belonging to a particular page, or the like.

The screen frame arrangement unit 140 may select a page on which the pattern of repetitive viewing of a particular page and the pattern of fluorescent-marking on sentences belonging to a particular page appear as a screen frame to be selected according to the book story, and a page on which the pattern of quickly passing through a particular page appears may be excluded from a screen frame to be selected according to the book story.

The above description is an embodiment for understanding the present disclosure, and a configuration in which an image generated by the image generation unit 120 and a sound generated by the audio generation unit 160 combines are described. A digital live book production system according to the present disclosure may be configured to automatically convert text into multimedia contents in which video images, animations, images, and audio are arranged through natural language parsing and data mining/text mining based on an artificial intelligence (AI) technology in a multimedia generation unit. Through this, digital contents (video media) and books may be fused and combined through an artificial intelligence base to provide a service in which Internet Protocol Television (IPTV), Video On Demand (VOD), streaming, platforms and applications are combined.

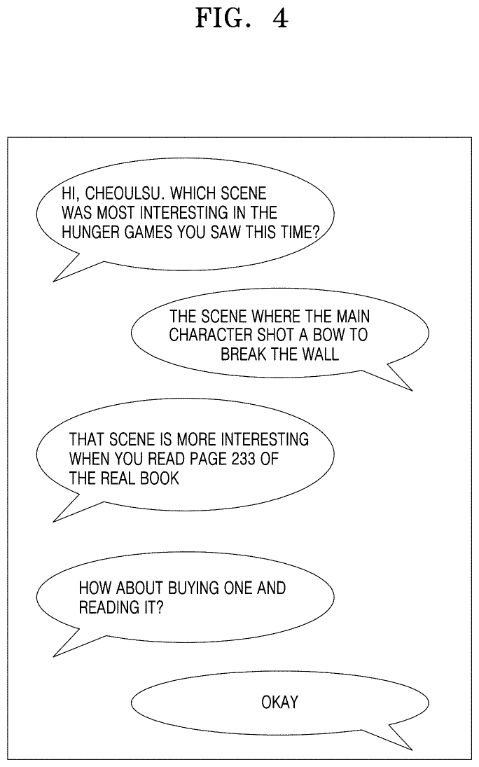

FIG. 4 is a diagram illustrating a case where a chatbot unit assigns a mission to a user terminal in a digital live book production system according to an embodiment of the present disclosure.

The chatbot unit 180 may transmit a mission related to a digital live book to the user terminal 10 of a user who has finished viewing the digital live book, and may transmit a message that prompts the user to perform the mission.

For example, the chatbot unit 180 may send a question message saying “Hi, Cheoulsu. Which scene was most interesting in The Hunger Games you saw this time?” to the user terminal 10, and when the user answers that “The scene where the main character shot a bow to break the wall”, the chatbot unit 180 may answer as “That scene is more interesting when you read page 233 of the real book. How about buying one and reading it?” or “That scene is really cool in the movie, and you may download and view it from the Google Play store” to prompt the user to perform a subsequent action.

When the user decides to purchase or rent a related book after encountering a digital live book and transmits a purchase or rental request message to the chatbot unit 180 for this purpose, the chatbot unit 180 may drive an e-commerce application that may purchase or rent the related book on the user terminal 10 to enable the user to easily purchase or rent the related book through online bookstores, offline bookstores, open markets, and e-commerce.

The digital live book production system may sample the summary and review of books after deep learning the contents of a large amount of books, and based on this, provide the user with a digital video content (digital live book content) that the user may understand and satisfy in a form of storytelling. The digital video content created in the above manner may be viewed through YouTube and TV platforms. In addition, a chatbox service may be provided such that a user may directly act (change management) with knowledge information (motivation) obtained through the digital video content, and accordingly, behavioral tasks may be continuously given to the user to change a behavioral pattern of the user. That is, the user may acquire knowledge information through the digital live book content in their daily life, and the behavioral change (change management) tasks of the user may be continuously fed back through a messenger service of the chatbox unit.

Functional operations described in the present disclosure and embodiments related to the subject of the present disclosure may be implemented in a digital electronic circuit, computer software, firmware, hardware, or a combination including one or more of them by including structures disclosed in the present disclosure and structural equivalents thereof.

Embodiments of the subject described in the present disclosure may be implemented as one or more computer program products, that is, one or more modules related to computer program instructions encoded on a tangible program medium for execution by a data processing device or to control an operation thereof. The tangible program medium may be a radio wave signal or a computer-readable medium. The radio wave signal is an artificially generated signal, such as a machine-generated electrical, optical, or electromagnetic signal, which is generated to encode information for transmission to an appropriate receiver device for execution by a computer. The computer-readable medium may be a machine-readable storage device, a machine-readable storage substrate, a memory device, a combination of materials that affect a machine-readable radio wave signal, or a combination of one or more of them.

Computer programs (also known as programs, software, software applications, scripts or code) may be written in any form of a compiled or interpreted language, or a programming language including a priori or procedural language, and may also be developed in any form by including stand-alone programs or modules, components, subroutines, or other units suitable for use in a computer environment.

Computer programs do not necessarily correspond to files in a file system. A program may be stored in a single file provided to a requested program, multiple interactive files (e.g., a file that stores one or more modules, subprograms, or a portion of code), or in a portion of a file that holds other programs or data (e.g., one or more scripts stored within a markup language document).

A computer program may be developed to be executed in multiple computers located at one site or distributed over a plurality of sites and interconnected by a communication network, or one computer.

Additionally, logic flows and structural block diagrams described in the present disclosure describe corresponding actions and/or particular methods supported by corresponding functions and operations supported by the disclosed structural units, and may also be used to construct corresponding software structures and algorithms, and equivalents thereof.

Processes and logic flows described in the present disclosure may be performed by one or more programmable processors executing one or more computer programs to perform functions by operating on input data and generating output.

A processor suitable for execution of computer programs includes, for example, both general-purpose and particular-purpose microprocessors and any one or more processors of any kind of digital computer. Generally, a processor receives instructions and data from read-only memory, random access memory, or both of them.

Key elements of a computer are one or more memory devices for storing instructions and data, and a processor for carrying out the instructions. In addition, computers are generally operatively coupled to receive data from, transfer data to, or perform both of these operations, for example, from one or more mass storage devices for storing data such as magnetic, magneto-optical disks or optical disks. However, the computer does not need to have such a device.

The present disclosure describes the best mode of the present disclosure, and provides embodiments to illustrate the present disclosure and to enable those skilled in the art to manufacture and use the present disclosure. The written specification is not intended to limit the present disclosure to specific terms presented.

Accordingly, although the present disclosure has been described in detail with reference to the above embodiments, those skilled in the art may remodel, change, and modify these embodiments without departing from the scope of the present disclosure. For example, to achieve the intended effect of the present disclosure, it is not necessary to separately include all functional blocks illustrated in the drawings or to follow all the orders illustrated in the drawings as the order shown, and it is revealed that it may fall within the technical scope of the present disclosure as described in the claims.

1. A digital live book production system comprising:
a content data base in which images corresponding to sentences are stored in advance;
a book input unit to which sentences of a book are input;
an image generation unit configured to take, from the content data base, images corresponding to contents of the sentences input to the book input unit and match the images for each sentence;
an image alignment unit configured to arrange images in one screen frame according to contents of a sentence;
a screen frame arrangement unit configured to select some screen frames and connect the selected screen frames according to a story of a book, to generate a digital live book; and
an e-book feedback unit configured to receive a reading pattern of an e-book subscribed to by members from e-book terminals of the members,
wherein the image alignment unit arranges images matching a sentence in one screen frame, and
the screen frame arrangement unit selects a screen frame comprising sentences corresponding to a page that members repeatedly viewed in the e-book, as a screen frame to be selected according to a book story.

2. The digital live book production system of claim 1, further comprising:
a chatbot unit configured to transmit a mission related to a digital live book to a user who has finished reading a digital live book and transmit a message that prompts the user to perform the mission.

3. (canceled)

4. (canceled)

5. (canceled)

6. The digital live book production system of claim 1, wherein the image alignment unit arranges images matching two or more sentences together in one screen frame.

7. (canceled)

8. (canceled)

9. The digital live book production system of claim 1, further comprising:
an audio generation unit configured to collect sounds corresponding to contents of the sentences input to the book input unit, match the collected sounds for each sentence, and output a sound when a screen frame comprising a sentence is displayed.
